(19) United States
(12) Patent Application Publication
(10) Pub. No.: US 2003/0152053 A1
(43) Pub. Date: Aug. 14, 2003

(54) WIRELESS LOCAL AREA NETWORK SYSTEM

(76) Inventors: DAVID H EVANS, CRAWLEY (GB); ROBERT FIFIELD, REDHILL (GB)

Correspondence Address: PHILIPS ELECTRONICS NORTH AMERICAN CORP, 580 WHITE PLAINS RD, TARRYTOWN, NY, 10591, US

(21) Appl. No.: 09/263,923

(22) Filed: Mar. 5, 1999

(30) Foreign Application Priority Data
Jun. 3, 1998 (GB) 9804626.1

(51) Int. Cl. H04J 3/24; H04L 12/56; H04B 7/212

(52) U.S. Cl. 370/338; 370/349; 370/395.1

(57) ABSTRACT

A wireless local area network system comprises an ATM switch (10) coupled to an access point (12) having a transceiver and a plurality of mobile terminals (14) each having a transceiver. The transceivers operate in accordance with an Orthogonal Frequency-Division Multiplexing (OFDM) transmission scheme having a plurality of channels. In response to the access point (12) polling the mobile terminals (14) enquiring if they want a time slot in the next down-link frame, those mobile terminals wanting a time slot transmit an E-burst on selected ones of the plurality of channels whose phases are selected to minimise the transmitted peak to mean envelope power. Optionally the E-burst can be modulated to provide a limited amount of signalling information.

The present invention relates to a wireless local area network (WLAN) system, particularly but not exclusively, a system operating in accordance with Orthogonal Frequency-Division Multiplexing (OFDM) transmission scheme for high speed WATM LANS.

WO97/47112 discloses a reservation-based wireless-packet switched (ATM) local area network which provides a medium access control (MAC) layer in which a reservation-based communications protocol is provided in which the protocol divides all MAC-based communications between a control channel and a data channel, the control channel and the data channel together making up a control-data frame (CDF).

An object of the present invention is to enhance the operation of such WLAN systems.

According to one aspect of the present invention there is provided a wireless local area network system comprising an ATM switch coupled to an access point having a transceiver and at least one mobile terminal having a transceiver, said transceivers operating in accordance with an Orthogonal Frequency-Division Multiplexing (OFDM) transmission scheme having a plurality of channels, characterised in that an E-burst generated by one of said transceivers is transmitted to the other of the transceivers on selected ones of the plurality of channels whose phases are selected to minimise the transmitted peak to mean envelope power.

According to another aspect of the present invention there is provided a method of operating a wireless local area network system comprising an ATM switch coupled to an access point having a transceiver and at least one mobile terminal having a transceiver, said transceivers operating in accordance with an Orthogonal Frequency-Division Multiplexing (OFDM) transmission scheme having a plurality of channels, characterised by one of said transceivers generating an E-burst and transmitting the E-burst on selected ones of the plurality of channels whose phases are selected to minimise the transmitted peak to mean envelope power.

The present invention will now be described, by way of example, with reference to the accompanying drawings, wherein:

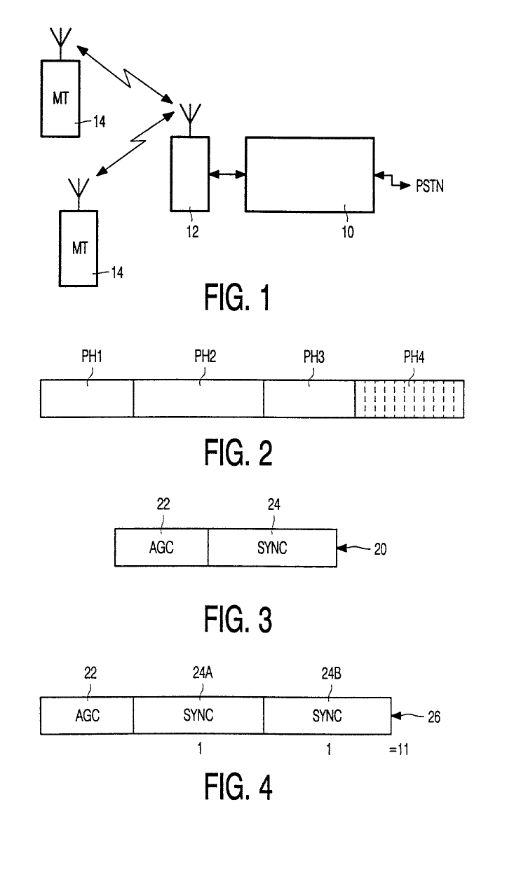

FIG. 1 is a block schematic diagram of a WLAN system,

FIG. 2 is a diagram of a control data frame (CDF),

FIG. 3 is a diagram of an E-burst,

FIGS. 4 and 5 are two examples of one method by which signalling information may be sent using E-bursts, and

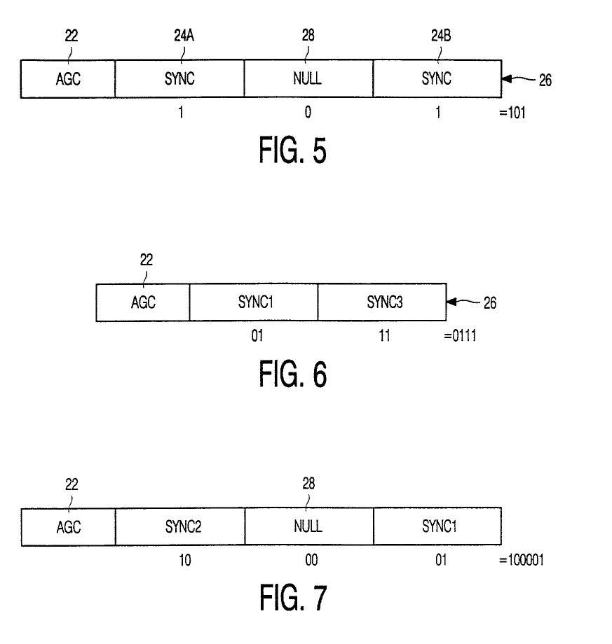

FIGS. 6 and 7 are two examples of another method by which signalling information may be sent using E-bursts.

In the drawings the same reference numerals have been used to represent corresponding features.

Referring to FIG. 1 the asynchronous transfer mode (ATM) WLAN system comprises an ATM switch 10 having a connection to the public switched telephone network PSTN or to a private network and a connection to an access point 12 which may comprise a base station transceiver or a mobile transceiver and which operates in accordance with OFDM. A plurality of mobile terminals 14 are provided which are able to roam within the radio coverage area of the base station transceiver 12. The mobile terminals 14 have transceivers which operate in accordance with OFDM. The access point 12 when operating in accordance with an OFDM transmission scheme transmits simultaneously on a plurality of radio channels and the mobile terminals receive on the plurality of radio channels. OFDM is preferred because the multipath propagation behaviour can be controlled with minimal transmission overheads.

In order to enable the mobile terminals 14 to access the same wireless channel there is a need for sending control messages to arbitrate a medium access control (MAC) protocol among the mobile terminals. In an embodiment of the present invention one medium access strategy involves the access point 12 polling all the mobile terminals 14 to determine if they have a message to send. The reply to such a polling message is simply a “Yes” or “No” answer which is signified by the presence or absence of what is termed an E-burst signal. In response to receiving the respective E-burst signals from a number of mobile terminals 14, the access point 12 allocates a certain number of slots in the following CDF to the responding mobile terminals. This method allows consideration of a very sporadic connection set up/release request and also a consideration of a regular slot access/release in the same framework.

FIG. 2 illustrates a CDF frame having four phases PH1, PH2, PH3 and PH4.

The first phase PH1 is the ATM switch signalling phase which implements a slot confirmation phase. The second phase PH2 is a downlink data transmission phase for the ATM switch 10 and the third phase PH3 is the uplink data transmission phase for the mobile terminals. Finally the fourth phase PH4 is the E-burst phase which implements the connection set up/release and part of the slot access/release functionality. This phase indicates whether a particular mobile terminal 14 requires any slots to transmit in the next CDF.

In its simplest implementation an E-burst is a brief burst of energy which can be detected by the intended receiver. Detection may be by means of a simple envelope detector or even the RSSI (Radio Signal Strength Indications). Since such an E-burst is a narrowband signal it will be susceptible to frequency selective fading and may not make the best use of the receiver bandwith. As an alternative the duration of the simple E-burst could be made shorter to match the bandwidth of the receiver. However since the peak power of the short burst is constrained by the same prescribed limit as a longer burst, the shorter burst has a much lower energy and is difficult to detect.

In accordance with the present invention the E-burst is configured to make full use of the receiver bandwidth and to contain maximum energy within a prescribed peak power constraint and as a consequence the detectability of the E-burst is enhanced. In one embodiment of the present invention the E-burst consists of a complete OFDM symbol with a number, if not all, of the sub-carriers being used. Additionally the phases of the selected sub-carriers are selected to minimise the transmitted peak to mean envelope power ratio. Since no data is carried within an E-burst, an optimum combination of carrier phases which gives the minimum can be selected freely. As a consequence of the peak to mean envelope power ratio being low, the mean power of an E-burst can be made higher than that for OFDM data symbols which also improves detection.

In practice the E-burst can be generated from a digital representation of a symbol waveform, which representation can be retained in a memory of the mobile terminal 14 (FIG. 1) ready for transmission. The representation comprises the required sub-carrier magnitude and phase information and when required they are read out and applied to a digital-to-analogue converter (DAC).

At the ATM switch 10, detection of the E-burst is performed by sampling the received E-burst to identify the presence of sub-carriers by correlation techniques.

There is more than one combination of sub-carrier phase states which gives the minimal peak to mean envelope ratio. This means that the E-burst can serve additional functions by modulating one or two of the sub-carriers so that one or two bits of signalling information can be contained within the E-burst, which signalling can be recovered and used by the ATM switch 10. The signalling information may comprise a request for an uplink transmission slot in the next CDF in a situation in which a mobile terminal does not transmit in successive frames or a registration request from a mobile terminal which has roamed into the coverage area of the access point 12. FIG. 3 illustrates one example of an E-burst 20. The E-burst comprises an AGC preamble field 22 concatenated with a synchronisation code word 24.

FIG. 4 illustrates one example of an E-burst 26 containing signalling information. The E-burst comprises an AGC preamble field 22 concatenated with duplicate versions 24A, 24B of the synchronisation code word. Each of the versions 24A, 24B represents a bit having binary value of “1”. Thus the signalling information comprises “11”. The ATM switch 10 decodes this information to provide a meaningful output.

FIG. 5 illustrates another example of an E-burst 26 in which a null code word representing binary “0” is interposed between the duplicate synchronisation code words 24A, 24B. Thus the signalling information comprises “101”.

FIGS. 6 and 7 represent a variant in which two bit symbols 01, 10, 11 are represented as respective synchronisation code words sync 1, sync 2, sync 3 and the symbol 00 is represented by a null code word 28. In each case the E-burst commences with an AGC preamble field 22. In FIG. 6, sync 1 and sync 2 are concatenated with the preamble field 22 to provide decoded information “0111”. In FIG. 7 sync 2 is separated from sync 1 by a null code word 28. When decoded, the information comprises “100001”.

In the examples of the E-burst shown in FIGS. 3 to 7, the synchronisation code word may have a high auto correlation to aid detection and avoid errors. The use of M-sequences may be particularly advantageous, since these have a high auto correlation and a low cross correlation, enabling different sequences to be distinguished readily.

Other variants are possible within the scope of the present invention as defined by the appended claims. An important consideration is that the encoded E-burst does not exceed the duration of its assigned time slot, otherwise it might be treated as data and be encoded as other data.

From reading the present disclosure, other modifications will be apparent to persons skilled in the art. Such modifications may involve other features which are already known in the design, manufacture and use of wireless local area network systems and component parts thereof and which may be used instead of or in addition to features already described herein.

1. A wireless local area network system comprising an ATM switch coupled to an access point having a transceiver and at least one mobile terminal having a transceiver, said transceivers operating in accordance with an Orthogonal Frequency-Division Multiplexing (OFDM) transmission scheme having a plurality of channels, characterised in that an E-burst generated by one of said transceivers is transmitted to the other of the transceivers on selected ones of the plurality of channels whose phases are selected to minimise the transmitted peak to mean envelope power.

2. A system as claimed in claim 1, characterised in that the transceivers have means for generating the E-burst from a digital representation of a symbol waveform.

3. A system as claimed in claim 1, characterised in that the transceivers have means for generating the E-burst from pre-stored information relating to sub-carrier magnitude and phase.

4. A system as claimed in claim 1, 2 or 3, characterised in that the transceiver generating the E-burst has means for modulating at least one of the selected ones of the plurality of channels with at least one bit signalling information.

5. A system as claimed in any one of claims 1 to 4, characterised in that an E-burst comprises an AGC preamble field concatenated with code words comprising encoded signalling information.

6. A system as claimed in claim 5, characterised in that the code words comprise null code word(s) and synchronisation code word(s).

7. A system as claimed in claim 5, characterised in that the code words comprise null code word(s) and different synchronisation code word(s) representative of respective symbols.

8. A system as claimed in claim 6 or 7, characterised in that each synchronisation code word has a high auto correlation.

9. A method of operating a wireless local area network system comprising an ATM switch coupled to an access point having a transceiver and at least one mobile terminal having a transceiver, said transceivers operating in accordance with an Orthogonal Frequency-Division Multiplexing (OFDM) transmission scheme having a plurality of channels, characterised by one of said transceivers generating an E-burst and transmitting the E-burst on selected ones of the plurality of channels whose phases are selected to minimise the transmitted peak to mean envelope power.

10. A method as claimed in claim 9, characterised in that the E-burst is generated from a digital representation of a symbol waveform.

11. A method as claimed in claim 9, characterised in that the E-burst is generated from pre-stored information relating to sub-carrier magnitude and phase.

12. A method as claimed in claim 9, 10 or 11, characterised in that the E-burst transmitted in at least one of the selected ones of the plurality of channels is modulated with at least one bit signalling information.

13. A method as claimed in any one of claims 9 to 12, characterised in that an E-burst comprises an AGC preamble field concatenated with code words comprising encoded signalling information.

14. A method as claimed in claim in claim 13, characterised in that the code words comprise null code words(s) and synchronisation code word(s).

15. A method as claimed in claim 13, characterised in that the code words comprise null code words(s) and different synchronisation code word(s) representative of respective symbols.

16. A method as claimed 14 or 15, characterised in that each synchronisation code word has a high auto correlation.
